(19) United States
(12) Patent Application Publication
(10) Pub. No.: US 2005/0042493 A1
(43) Pub. Date: Feb. 24, 2005

(54) Fuel cell device

(75) Inventors: Goro Fujita, Ota-shi (JP); Hiroki Kabumoto, Saitama-shi (JP); Masaya Yano, Oura-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/915,440

(22) Filed: Aug. 11, 2004

(30) Foreign Application Priority Data
Aug. 22, 2003 (JP) 2003-299205

(51) Int. Cl. H01M 8/24; H01M 8/02

(52) U.S. Cl. 429/34; 429/38; 429/37

(57) ABSTRACT

There is provided a compact and light-weight fuel cell device. The fuel cell device has a structure where a plurality of substantially horizontally-disposed cells are vertically piled to form a stack, on whose ends there are end plates and the stack is tightened with two bands. Each cell comprises an MEA comprising a pair of electrode layers and a reaction layer therebetween, and conductive separators sandwiching the MEA in which channels for flowing liquids such as a gas and a liquid fuel are formed. An unreformed organic liquid fuel is directly fed to an anode, while oxygen-containing air is fed to a cathode. In the upper part of the fuel cell device, there are an air inlet and a fuel outlet, while in the lower part of the opposite side there are an air outlet and a fuel inlet.

### BACKGROUND OF THE INVENTION

1. Field of the Invention

The present invention relates to a fuel cell device. In particular, it relates to a fuel cell device utilizing an organic liquid fuel.

2. Description of the Related Art

In recent years, a direct methanol fuel cell (DMFC) has come to attract attention as a type of fuel cell. A DMFC generates electric power by directly feeding methanol as an unreformed fuel for an electrochemical reaction between methanol and oxygen. Methanol has higher energy per a unit volume than hydrogen and is suitable for storage and relatively nonexplosive. Thus, it is expected to be used in a power source for an automobile, a cellular phone or the like (See, for example Patent Reference 1).

For using a fuel cell as a power source for a mobile device, further size and weight reduction of the fuel cell is needed. We have devised a technique for reducing the size and the weight of a fuel cell in various aspects. Specifically, we have developed a technique whereby a power generating efficiency per a cell can be improved and the number of cells in a stack can be reduced to reduce the size and the weight of a fuel cell. We have also developed a technique whereby the size and the weight of a structure for fastening a stack can be reduced to reduce the size and the weight of a fuel cell.

Patent reference 1:
Japanese Laid-open Patent Publication No. 2002-56856.

Patent Reference 2:
Japanese Laid-open Patent Publication No. 2001-135343.

### SUMMARY OF THE INVENTION

In view of the problems, an objective of the present invention is to provide a technique for realizing a safe fuel cell system.

In view of the problems, an objective of this invention is to provide a technique for reducing the size and the weight of a fuel cell device.

An aspect of this invention relates to a fuel cell device. The fuel cell device has a structure where a plurality of cells are stacked, the cell consisting of a pair of electrode layers and a reaction layer sandwiched between the electrode layers, wherein the upper and the lower electrode layers in the cell act as an anode and a cathode, respectively. An organic liquid fuel and oxygen may be fed to the anode and the cathode, respectively. In the upper anode, the organic liquid fuel and carbon dioxide generated are separated into a lower liquid and an upper gaseous phases in a channel, so that the organic liquid fuel can be efficiently contacted with the electrode layer. In the lower cathode, oxygen and water generated are separated into a lower liquid and an upper gaseous phases in a channel so that oxygen can be efficiently contacted with the electrode layer. Thus, a power generating efficiency can be improved, and resultantly it can contribute to reduction in the size and the weight of a fuel cell device.

Another aspect of this invention also relates to a fuel cell device. The fuel cell device comprises a stack having a structure where a plurality of cells are stacked, the cell consisting of a pair of electrode layers and a reaction layer sandwiched between the electrode layers; a first manifold for feeding an organic liquid fuel to the plurality of cells; a second manifold for discharging the organic liquid fuel fed to the plurality of cells; and an outlet for the organic liquid fuel provided in the upper part of the second manifold. The device may further comprise a feeding port for an organic liquid fuel provided in the lower part of the first manifold. The outlet for an organic liquid fuel provided in the upper part permits a produced gas after gas-liquid separation in the second manifold in the outlet side to be efficiently discharged. Thus, a power generating efficiency can be improved, and resultantly it can contribute to reduction in the size and the weight of a fuel cell device.

A further aspect of this invention also relates to a fuel cell device. The fuel cell device comprises a stack having a structure where a plurality of cells are stacked, the cell consisting of a pair of electrode layers and a reaction layer sandwiched between the electrode layers; a first manifold for feeding an oxygen-containing gas to the plurality of cells; a second manifold for discharging the oxygen-containing gas fed to the plurality of cells; and an outlet for the oxygen-containing gas provided in the lower part of the second manifold. The device may further comprise a feeding port for an oxygen-containing gas provided in the upper part of the first manifold. The outlet for an oxygen-containing gas provided in the lower part permits water produced after gas-liquid separation in the second manifold in the outlet side to be efficiently discharged. Thus, a power generating efficiency can be improved, and resultantly it can contribute to reduction in the size and the weight of a fuel cell device.

A further aspect of this invention also relates to a fuel cell device. The fuel cell device comprises a pair of electrode layers, a reaction layer sandwiched between the electrode layers, and a pair of separators adjacent to the sides of the electrode layers opposite to the sides facing the reaction layer, wherein in the anode side, the separator adjacent to the electrode layer has a channel for an organic liquid fuel fed to the anode such that the upstream part of the channel near a feeding port for the organic liquid fuel is narrower than the downstream part of the channel near the outlet. Since the area of the more reactive upstream part of the channel is larger than the area of the less reactive downstream, a power generating efficiency can be improved as a whole cell, and resultantly it can contribute to reduction in the size and the weight of a fuel cell device.

A further aspect of this invention also relates to a fuel cell device. The fuel cell device comprises a stack having a structure where a plurality of cells are stacked, the cell consisting of a pair of electrode layers and a reaction layer sandwiched between the electrode layers; a pair of end plates on both sides of the stack; and a band for fastening the stack, wherein the end plates have a fastening part for tightening the band. The fastening part in an empty space in the end plate can reduce the size and the weight of a fuel cell device.

The fuel cell device may have two bands described above and the fastening parts for tightening one band and the other band may be formed in different end plates. The two bands can be alternately tightened to uniformly fasten the whole stack. Thus, a power generating efficiency can be improved, and resultantly it can contribute to reduction in the size and the weight of a fuel cell device. Furthermore, it can prevent deterioration in the electrode layers or the reaction layer due to local proceeding of the reaction caused by uneven tightening. The band may have an accordion or slit structure to be elastic for reducing slack in the band.

The fastening part may comprise a pair of fixing parts for fixing both ends of the band; and a moving part for moving the fixing part in a direction substantially perpendicular to the lamination direction of the cells for tightening the band. Thus, the size of the fastening part may be reduced, and resultantly it can contribute to reduction in the size and the weight of a fuel cell device.

Another aspect of this invention also relates to a fuel cell device. The fuel cell device comprises a stack having a structure where a plurality of cells are stacked, the cell consisting of a pair of electrode layers and a reaction layer sandwiched between the electrode layers; and a pair of end plates on both sides of the stack, wherein the end plates comprise a port for a fluid fed to the electrode layer and a channel communicating a manifold for feeding the fluid to the cell or discharging the fluid from the cell with the port. The channel communicating the manifold with the port can be formed in an empty space in the end plate to reduce the size and the weight of a fuel cell device. The width of the port may be narrower than the width of the manifold such that the channel has a shape smoothly broadening from the port toward the manifold. The manifold and the port with different widths can be smoothly connected to realize smooth flow of the fluid.

Any given combination of the components described above as well as methods, apparatuses and systems among which an expression of the present invention is appropriately modified can be effective as aspects of the present invention.

Moreover, this summary of the invention does not necessarily describe all necessary features so that the invention may also be sub-combination of these described features.

### BRIEF DESCRIPTION OF THE DRAWINGS

FIG. 1 schematically shows the appearance of a fuel cell device according to an embodiment.

FIG. 2A, FIG. 2B and FIG. 2C are a plan, a front and a side views for the fuel cell device shown in FIG. 1, respectively.

FIG. 3 shows relationship between an MEA and channels for a fuel and air.

FIG. 4A shows a channel for air within a stack and FIG. 4B shows a channel for an organic liquid fuel in the stack.

FIG. 5 shows a channel for a liquid fuel formed in a separators.

FIG. 6 shows the structure of an end plate.

FIG. 7 illustrates a method for tightening a stack with a band.

FIG. 8 shows an end of a band fixed to a fastening block.

FIG. 9A and FIG. 9B show other examples of a band.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

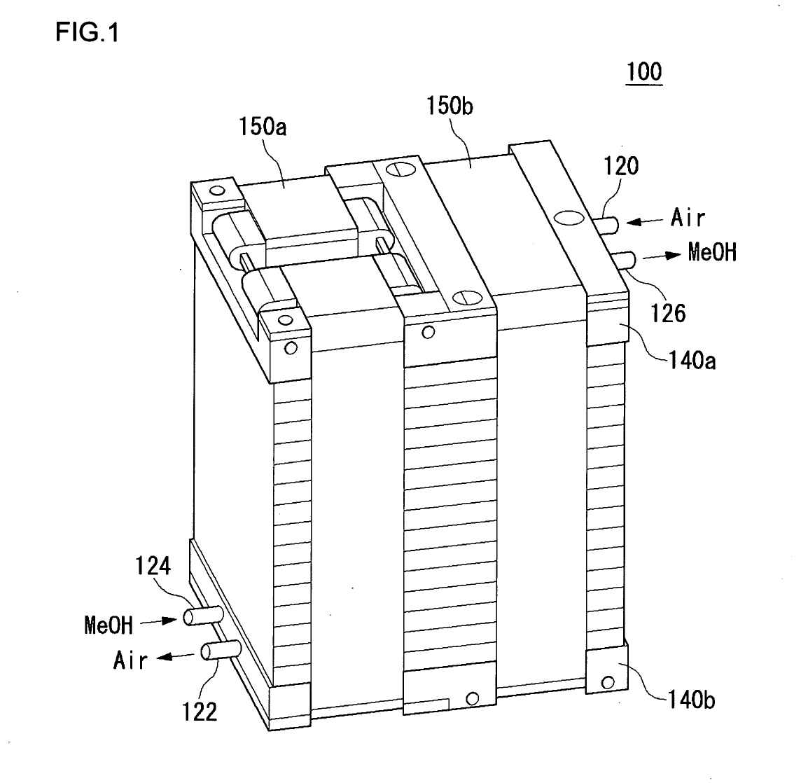

FIG. 1 schematically shows the appearance of a fuel cell device 100 according to an embodiment. The fuel cell device 100 has a structure where a plurality of substantially horizontally-disposed cells are vertically piled to form a stack, on whose ends there are end plates 140a and 140b and the stack is tightened with two bands 150a and 150b. Each cell comprises an membrane electrode assembly (hereinafter, referred to as “MEA”) comprising a pair of a cathode and an anode layers and a reaction layer therebetween, e. g., a proton-conductive polymer electrolyte membrane such as Nafion, and conductive separators sandwiching the MEA in which channels for flowing liquids such as a gas and a liquid fuel are formed. A diffusion layer for evenly diffusing a gas or liquid fuel over a film may be provided between the MEA and the separator. In the fuel cell device 100 according to this embodiment, an unreformed organic liquid fuel such as alcohols (e. g., methanol and ethanol) and ethers is directly fed to an anode, while oxygen-containing air is fed to a cathode. In the upper part of the fuel cell device 100, there are an air inlet 120 and a fuel outlet 126, while in the lower part of the opposite side there are an air outlet 122 and a fuel inlet 124.

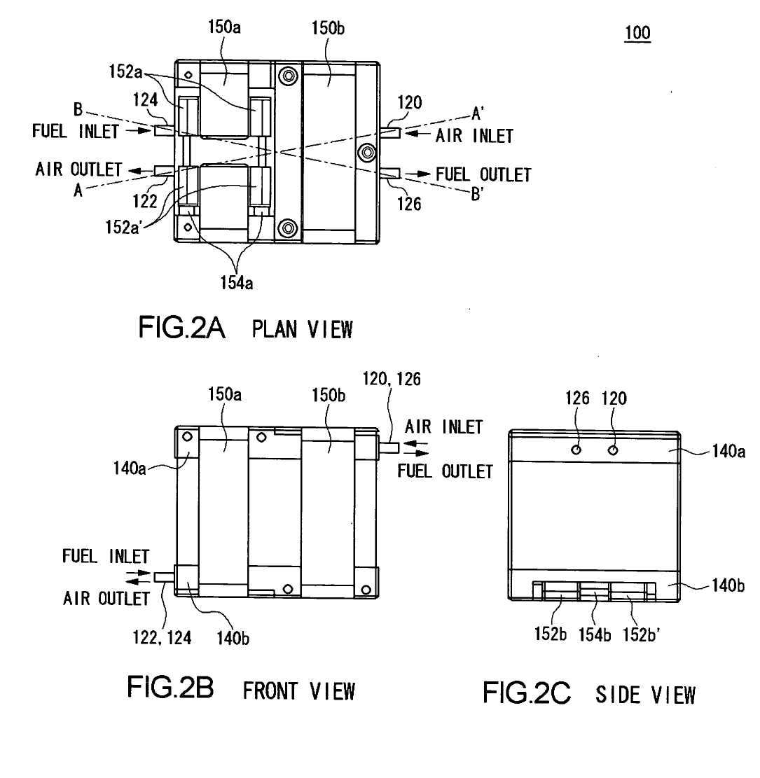

FIG. 2A, FIG. 2B and FIG. 2C are a plan, a front and a side views for the fuel cell device 100 shown in FIG. 1, respectively. A band 150a is fixed at the ends to fastening blocks 152a and 152a′ formed in the upper surface of the fuel cell device 100, and tightened with a bolt 154a. A band 150b is fixed at the ends to fastening blocks 152b and 152b′ formed in the lower surface of the fuel cell device 100, and tightened with a bolt 154b. Thus, the two bands 150a and 150b can be alternately tightened to evenly fasten the stack as described later. Placing a fuel cell device 100 as shown in FIG. 1, there are an air inlet 120 and a fuel outlet 126 on the observers' right and left, respectively, in the side of the upper end plate 140a, while there are an air outlet 122 and a fuel inlet 124 on the observers' right and left, respectively, in the side of the lower end plate 140b.

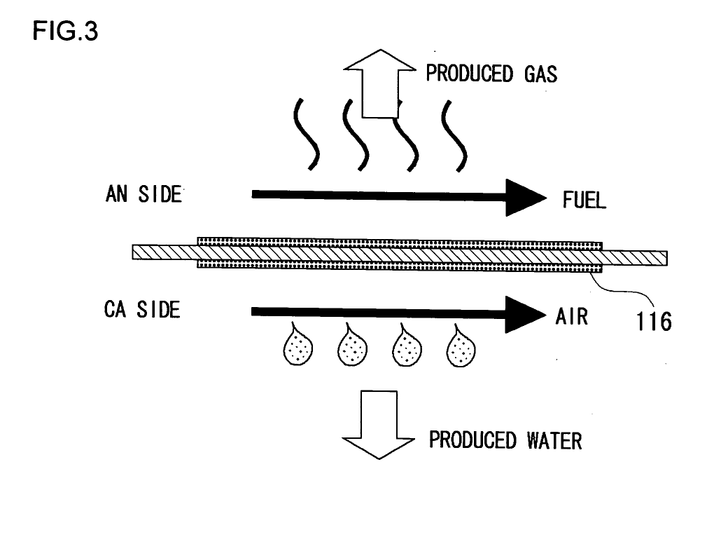

FIG. 3 shows relationship between an MEA and channels for a fuel and air. The stack in the fuel cell device 100 according to this embodiment has a structure where horizontally-disposed MEAs 116 are vertically piled, and a liquid fuel and air are fed to the upper and the lower parts of the MEA 116, respectively. That is, the upper and the lower parts of the MEA 116 are an anode and a cathode, respectively. In the anode side, an organic liquid fuel such as methanol reacts with water to generate carbon dioxide and hydrogen ions. Therefore, a downstream part in the channel for an organic liquid fuel contains more carbon dioxide, undesirably causing reduction in a contact efficiency between the organic liquid fuel and the MEA 116. However, since the upper part of the MEA 116 is an anode in this embodiment, carbon dioxide generated and the organic liquid fuel in the channels and the diffusion layer are gas-liquid separated upward and downward, respectively. Therefore, even in the downstream part of the channel, the organic liquid fuel can be efficiently contacted with the MEA 116. Thus, a power generating efficiency can be improved. In the cathode side, oxygen in air reacts with hydrogen ions to generate water. However, since the lower part of the MEA 116 is a cathode, water generated and air in the channels and the diffusion layer are gas-liquid separated downward and upward, respectively. Therefore, even in the downstream part of the channel, air can be efficiently contacted with the MEA 116. Thus, a power generating efficiency can be improved.

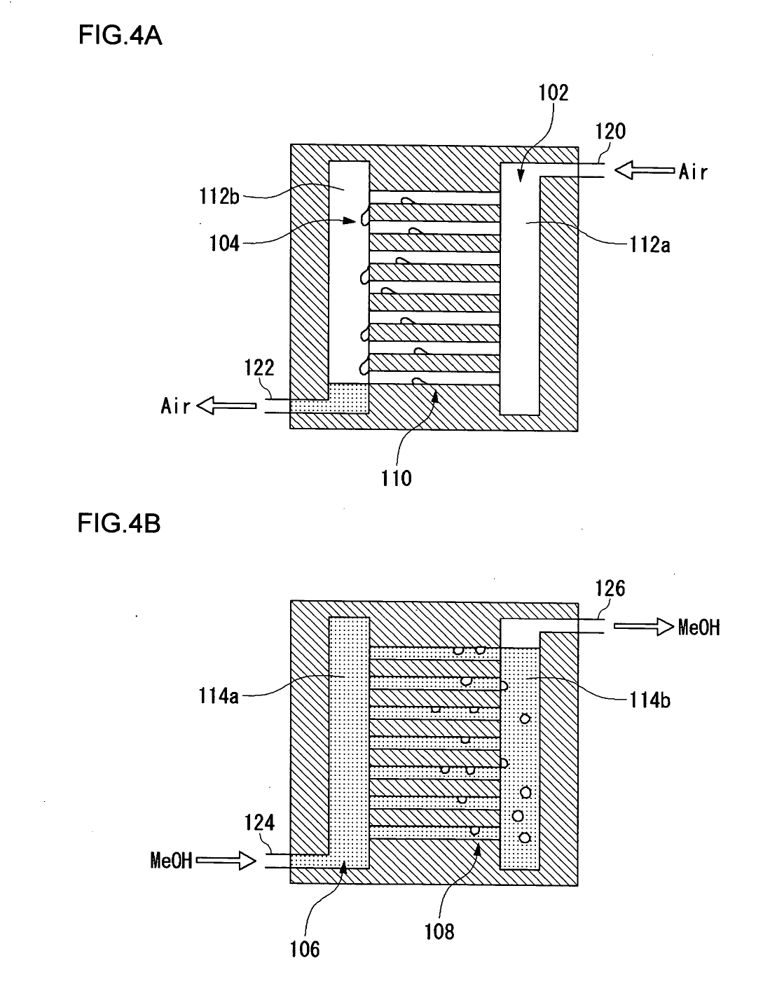

FIG. 4A and FIG. 4B show channels for air and an organic liquid fuel within a stack, respectively. FIG. 4A corresponds to a cross-section taken on line A-A′ of FIG. 2A, while FIG. 4B corresponds to a cross-section taken on line B-B′ of FIG. 2A. As shown in FIG. 4A, an air inlet 120 is formed in the upper part of one side of the fuel cell device 100 and an air outlet 122 is formed in the lower part of the opposite side. Air 102 is fed from the air inlet 120 through an inlet manifold 112a to each cell in a stack 110. Water 104 generated and unreacted air 102 in each cell are gas-liquid separated in an outlet manifold 112b and discharged from an air outlet 122. Thus, the outlet manifold 112b can be also used as a gas-liquid separation chamber to provide a simpler structure, which may contribute to reduce the size and the weight of the device. Furthermore, the air outlet 122 disposed in the lower part can enhance discharge of water generated and thus contribute improvement of a power generating efficiency.

As shown in FIG. 4B, the fuel inlet 124 is formed in the lower part of one side in the fuel cell device 100 and the fuel outlet 126 is formed in the upper part of the opposite side. The organic liquid fuel 106 is fed from the fuel inlet 124 through an inlet manifold 114a to each cell in the stack 110. Carbon dioxide 108 generated and unreacted organic liquid fuel 106 in each cell are gas-liquid separated in an outlet manifold 114b and discharged from the fuel outlet 126. Thus, the outlet manifold 114b can be also used as a gas-liquid separation chamber to provide a simpler structure, which may contribute to reduce the size and the weight of the device. Furthermore, the fuel outlet 126 disposed in the upper part can enhance discharge of carbon dioxide generated and thus contribute improvement of a power generating efficiency.

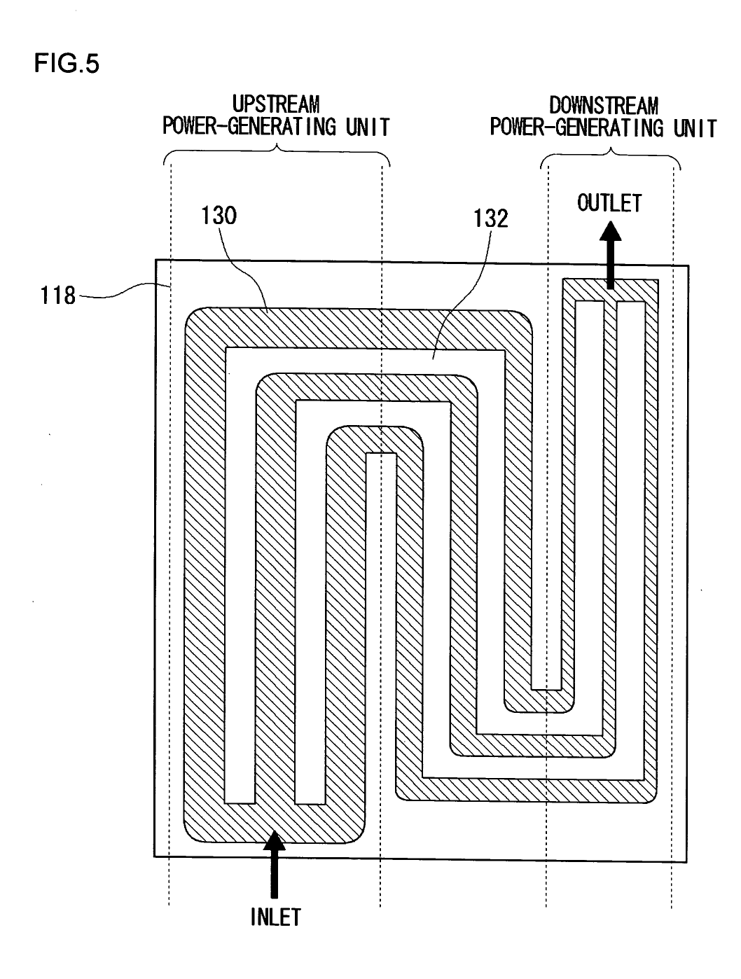

FIG. 5 shows a channel for a liquid fuel formed in a separator. An organic liquid fuel is fed from an inlet manifold 114a to each cell and then passes through a channel 130 formed in a separator 118 and discharged from an outlet manifold 114b. In the downstream part of the channel 130, the organic liquid fuel is thinner than in the upstream part because of consumption by a cell reaction and a rate of a produced gas is increased, leading to deterioration in reaction activity and a reduced power generating efficiency. Thus, in the upstream part with higher reactivity, the channel is wider and a channel area is larger to improve a power generating efficiency while in the downstream part with lower reactivity, the channel is narrower and a channel area is smaller to increase a flow rate and enhance discharge of carbon dioxide generated. Thus, a power generating efficiency can be improved as a whole cell. A width of a rib 132 acting as a collector may be constant as shown in FIG. 5 or may be gradually tapered toward the downstream part. The widths of the channel for an organic liquid fuel and the rib are preferably determined, taking a power generating efficiency and collection ability of the whole cell into account.

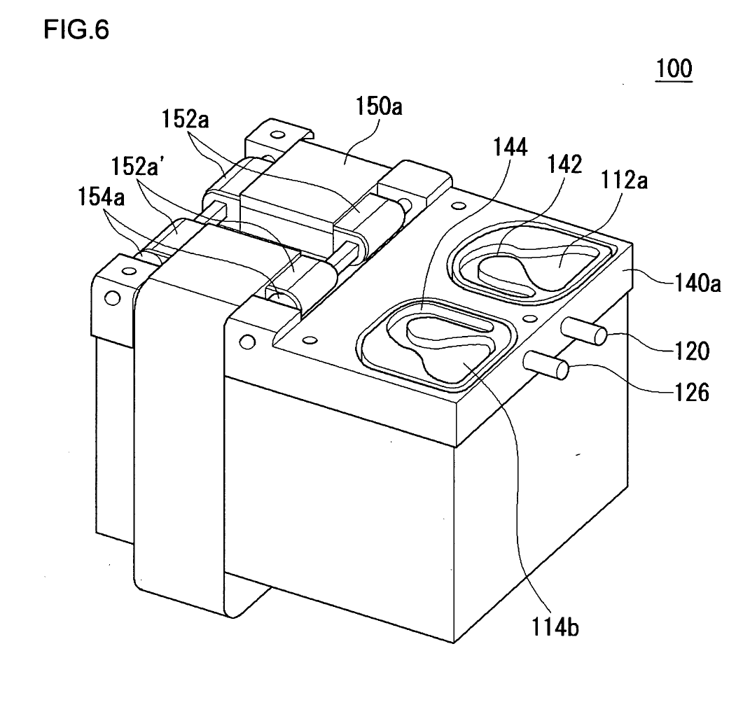

FIG. 6 shows a structure of an end plate. In FIG. 6, the band 150b in the configuration of the fuel cell device 100 shown in FIGS. 1 and 2 is removed to expose the right half of the upper end plate 140a. The left half of the upper end plate 140a in FIG. 6 comprises a fastening part for tightening the band 150a; specifically, fastening blocks 152a and 152a′ as an example of a fixed part and a bolt 154a as an example of a moving part. The right half comprises a channel 142 connecting the air inlet 120 with the air inlet manifold 112a and a channel 144 connecting the fuel outlet manifold 114b with the fuel outlet 126. The channel 142 has a shape smoothly broadening from the width of the air inlet 120 to the width of the air inlet manifold 112a. Air can be evenly fed to the whole length of the manifold 112a by introducing air via the channel 142 rather than directly introducing from the air inlet 120 to the air inlet manifold 112a. Similarly, the channel 144 has a shape smoothly tapered from the width of the fuel outlet manifold 114b to the width of the fuel outlet 126. The liquid fuel can be smoothly discharged via the channel 144 rather than directly from the fuel outlet manifold 114b to the fuel outlet 126.

Although not shown, the lower end plate 140b also has fastening blocks 152b and 152b′ and a bolt 154b for tightening a band 150b in the right half in FIG. 6 as well as a channel connecting the air outlet manifold 112b with an air outlet 122 and a channel connecting the fuel inlet 124 with the fuel inlet manifold 114a. These channels have the same shapes as in the channels 142 and 144, respectively, for smooth flowing of a fluid.

In this embodiment, the end plates 140a and 140b disposed for applying a bearing to the stack comprise a unit for tightening the band 150, the ports for a liquid fuel and air, and the channels connecting them with the manifolds. Thus, the size and the weight of a fuel cell device 100 can be reduced. For providing the channels shown in FIGS. 4 and 5, the ports for a fuel and air are formed in the right half of the upper end plate 140a and in the left half of the lower end plate 140b. The fastening blocks 152 for the two bands 150a and 150b are provided in the left half of the upper end plate 140a and in the right half of the lower end plate 140b. Thus, the empty space can be effectively used. resulting in reduction of the size and the weight of the fuel cell device 100. Since the fastening blocks 152 for the bands 150 are alternately provided as described above, there is provided another advantage that the stack can be evenly tightened as described below. The corner in the end plate 140a with which the band 150a comes into contact is rounded. Thus, it can reduce possibility of breakage of the band 150 when it is strongly tightened.

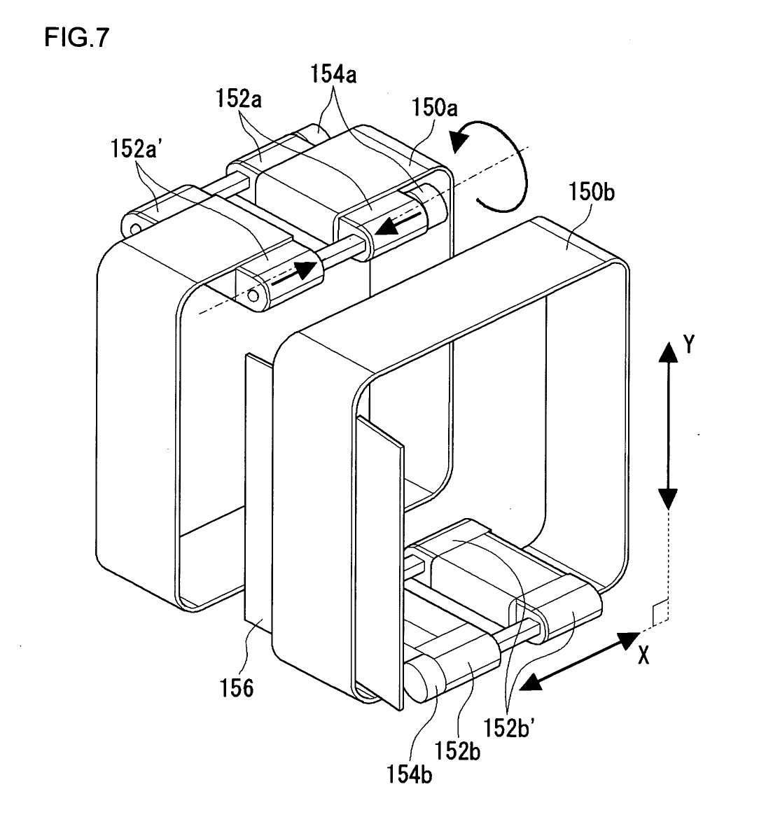

FIG. 7 illustrates a method for tightening a stack with a band. In this embodiment, a stack consisting of piled cells is fastened by the end plates 140 and the band 150 to apply a given bearing between an electrode in each cell and a polymer film. Thus, a fuel and air can be tightly sealed and the electrode can be firmly attached to a separator to reduce an impedance. However, if a bearing applied to the cell is uneven, the separator may be broken in an area with a stronger bearing while increase of an impedance and/or leak of the fuel or air may occur in an area with a weaker bearing. It is, therefore, essential to apply an even bearing to the cells. In this embodiment, an even bearing is applied to the cells by alternately tightening the stack sandwiched between the two end plates 140a and 140b with the two bands 150a and 150b.

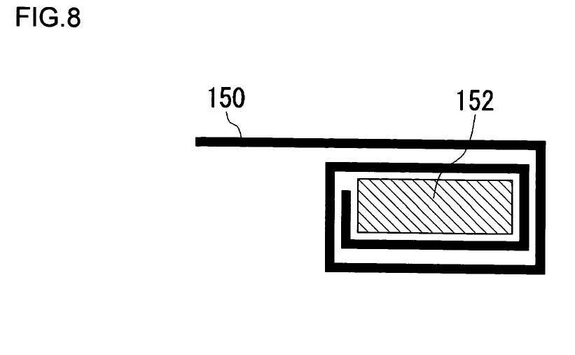

First, the ends of the band 150a are wound around the fastening blocks 152a and 152a′ , respectively, as shown in FIG. 8. Then, the bolt 154a is turned to move the fastening blocks 152a and 152a′ such that they come closer to each other (in the direction indicated by an arrow in FIG. 7) for tightening the band 150a to a given force. It is preferable to tighten the band to a bearing of about 20 kgf/cm2. Similarly, the ends of the band 150b are wound around the fastening blocks 152b and 152b′ for fixing and tightened by turning the bolt 154b. The fastening blocks 152a and 152a′ of the band 150a and the fastening block 152b and 152b′ of the band 150b are alternately provided in the upper and the lower end plates 140a and 140b, respectively. Thus, the whole stack can be evenly fastened.

According to the fastening method of this embodiment, a tightening direction of the fastening block 152 (the direction indicated by an arrow X in FIG. 7) is substantially perpendicular to the piling direction of the stack (the direction indicated by an arrow Y in FIG. 7) in contrast to the fastening method disclosed in Patent Reference 2. Thus, a unit for fastening the stack can be placed in the plane of the end plate 140, which can contribute to reduction of the size and the weight of the whole fuel cell device 100.

In this embodiment, an insulating part 156 such as a Teflon sheet and an insulating rubber is provided because the band 150 is made of stainless steel. Alternatively, the band 150 may be a Teflon sheet or insulating rubber and in such a case, an insulating part 156 is not necessary.

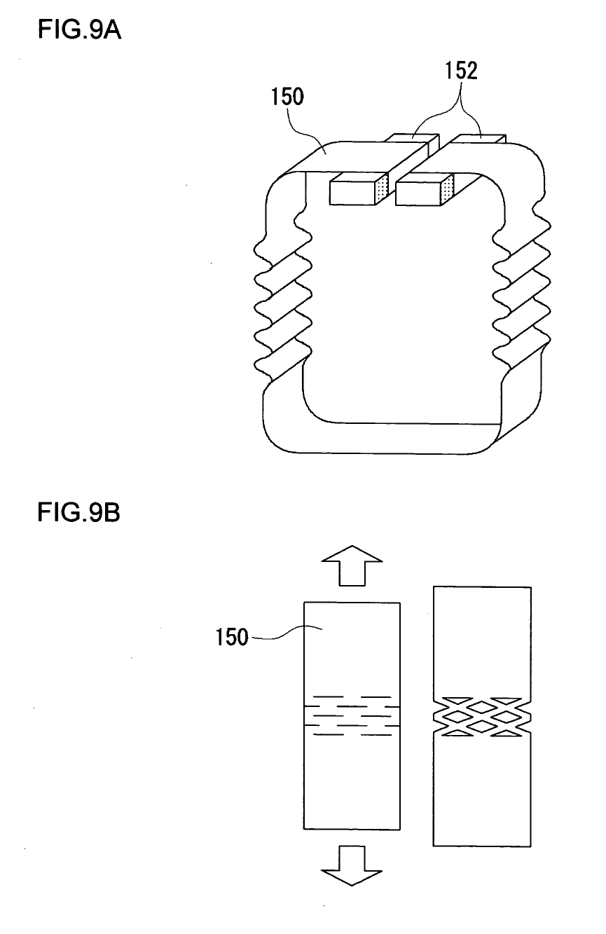

FIG. 9A and FIG. 9B show other examples of the band 150. FIG. 9A shows an example where the band 150 has an accordion structure for making the band resilient. FIG. 9B shows an example where a slit is formed for making the band 150 resilient. The band may be thus made resilient to maintain a tension for fastening the band 150 and to reduce slack. As an alternative example, the band 150 itself may be made of an elastic material such as rubber.

The present invention has been described with reference to the preferred embodiments. It will be, however, understood by one skilled in the art that these embodiments are just illustrative and that there may be many variations in a combination of the components or the process steps and all of such variations are within the scope of the present invention which is defined by the appended claims.

1. A fuel cell device having a structure where a plurality of cells are vertically stacked, the cell consisting of a pair of electrode layers and a reaction layer sandwiched between the electrode layers,
wherein the upper and the lower electrode layers in the cell act as an anode and a cathode, respectively.

2. The fuel cell device as claimed in claim 1 wherein an organic liquid fuel and oxygen are fed to the anode and the cathode, respectively.

3. A fuel cell device comprising:
a stack having a structure where a plurality of cells are stacked, the cell consisting of a pair of electrode layers and a reaction layer sandwiched between the electrode layers;
a first manifold for feeding an organic liquid fuel to the plurality of cells;
a second manifold for discharging the organic liquid fuel fed to the plurality of cells; and
an outlet for the organic liquid fuel provided in the upper part of the second manifold.

4. The fuel cell device as claimed in claim 3, further comprising a feeding port for an organic liquid fuel provided in the lower part of the first manifold.

5. A fuel cell device comprising:
a stack having a structure where a plurality of cells are stacked, the cell consisting of a pair of electrode layers and a reaction layer sandwiched between the electrode layers;
a first manifold for feeding an oxygen-containing gas to the plurality of cells;
a second manifold for discharging the oxygen-containing gas fed to the plurality of cells; and
an outlet for the oxygen-containing gas provided in the lower part of the second manifold.

6. The fuel cell device as claimed in claim 5, further comprising a feeding port for an oxygen-containing gas provided in the upper part of the first manifold.

7. The fuel cell device as claimed in claim 3, wherein the second manifold acts as a gas-liquid separation chamber.

8. The fuel cell device as claimed in claim 4, wherein the second manifold acts as a gas-liquid separation chamber.

9. The fuel cell device as claimed in claim 5, wherein the second manifold acts as a gas-liquid separation chamber.

10. The fuel cell device as claimed in claim 6, wherein the second manifold acts as a gas-liquid separation chamber.

11. A fuel cell device comprising:
a pair of electrode layers;
a reaction layer sandwiched between the electrode layers; and
a pair of separators adjacent to the sides of the electrode layers opposite to the sides facing the reaction layer,
wherein in the anode side, the separator adjacent to the electrode layer has a channel for an organic liquid fuel fed to the anode such that the upstream part of the channel near a feeding port for the organic liquid fuel is narrower than the downstream part of the channel near the outlet.

12. A fuel cell device comprising:
a stack having a structure where a plurality of cells are stacked, the cell consisting of a pair of electrode layers and a reaction layer sandwiched between the electrode layers;
a pair of end plates on both sides of the stack; and
a band for fastening the stack,
wherein the end plates have a fastening part for tightening the band.

13. The fuel cell device as claimed in claim 12 comprising the two bands,
wherein the fastening parts for tightening one band and the other band are formed in different end plates.

14. The fuel cell device as claimed in claim 12, wherein the bands have an accordion or slit structure to be elastic.

15. The fuel cell device as claimed in claim 13, wherein the bands have an accordion or slit structure to be elastic.

16. The fuel cell device as claimed in claim 12, wherein the fastening part comprises a pair of fixing parts for fixing both ends of the band; and
a moving part for moving the fixing part in a direction substantially perpendicular to the stack direction of the cells for tightening the band.

17. A fuel cell device comprising:
a stack having a structure where a plurality of cells are stacked, the cell consisting of a pair of electrode layers and a reaction layer sandwiched between the electrode layers; and
a pair of end plates on both sides of the stack; the end plates comprising:
a port for a fluid fed to the electrode layer; and
a channel communicating a manifold for feeding the fluid to the cell or discharging the fluid from the cell with the port.

18. The fuel cell device as claimed in claim 17, wherein the width of the port is narrower than the width of the manifold such that the channel has a shape smoothly broadening from the port toward the manifold.
